(19) United States
(12) Patent Application Publication
(10) Pub. No.: US 2026/0117900 A1
(43) Pub. Date: Apr. 30, 2026

(54) FLOW PATH STRUCTURE AND METHOD FOR MANUFACTURING FLOW PATH STRUCTURE

(71) Applicant: AISIN CORPORATION, Kariya (JP)

(72) Inventor: Hiroyoshi IWAMURA, Kariya-shi (JP)

(73) Assignee: AISIN CORPORATION, Kariya (JP)

(21) Appl. No.: 19/370,343

(22) Filed: Oct. 27, 2025

(30) Foreign Application Priority Data
Oct. 29, 2024 (JP) 2024-189576
Sep. 30, 2025 (JP) 2025-162892

(51) Int. Cl. F16L 13/11; B60H 1/32; F16L 41/03

(52) U.S. Cl. CPC F16L 13/11; F16L 41/03; B60H 1/3229

(57) ABSTRACT

A flow path structure includes a first member including a first flow path allowing fluid to flow therein, a second member including a second flow path allowing the fluid to flow therein, and a tubular connection member provided over the first and second members and configured to cause the first and second flow paths to communicate with each other. The connection member includes a tubular portion extending along an axial direction, a first flange portion integrally provided on one end side of the tubular portion and having an outer diameter larger than the tubular portion outer diameter, and a second flange portion integrally provided on the other end side of the tubular portion and having an outer diameter larger than the tubular portion outer diameter. Brazed portions exist by brazing between the first flange portion and the first member and between the second flange portion and the second member, respectively.

### CROSS REFERENCE TO RELATED APPLICATIONS

This application is based on and claims priority under 35 U.S.C. § 119 to Japanese Patent Applications 2024-189576, filed on Oct. 29, 2024, and 2025-162892, filed on Sep. 30, 2025, the entire content of which is incorporated herein by reference.

### TECHNICAL FIELD

This disclosure relates to a flow path structure that allows a fluid to flow and a method for manufacturing such a flow path structure.

### BACKGROUND DISCUSSION

Many fluids such as a cooling liquid and a refrigerant are used in vehicles. Such a fluid is used in many devices via a flow path provided in a vehicle. In such a flow path, since a fluid having a relatively high pressure flows, a technique for appropriately connecting the flow path and the device has been studied.

JP 2017-215057A (Reference 1) discloses a liquid-cooled-type cooling device (1). In the liquid-cooled-type cooling device (1), in a state where one end side of an inlet pipe (6) is inserted into a through hole (29) of an inlet header (3), brazing is performed over the inlet header (3) and a first annular convex portion (27) protruding radially outward from an outer peripheral surface of the inlet pipe (6) on the one end side of the inlet pipe (6), and then, in a state where a first flange plate (21) is placed axially outward of a second annular convex portion (28) protruding radially outward from the outer peripheral surface of the inlet pipe (6) on the other end side of the inlet pipe (6), brazing is performed over the first flange plate (21) and the inlet pipe (6). Thereafter, a first pipe joint member (22) is provided axially outward from the inlet pipe (6) with respect to the inlet pipe (6) and the first flange plate (21), and brazing is performed between the first flange plate (21) and the first pipe joint member (22).

In the liquid-cooled-type cooling device (1) disclosed in Reference 1, when the inlet header (3) and the first pipe joint member (22) are to be connected to each other by the inlet pipe (6) as described above, a brazing step is required to be performed at least three times. Therefore, when the number of portions where two members such as the inlet header (3) and the first pipe joint member (22) in Reference 1 are to be connected to each other by a connection member such as the inlet pipe (6) increases, the brazing step is complicated, a time required for the brazing step is required, and a manufacturing cost increases.

A need thus exists for a flow path structure and a method for manufacturing such a flow path structure which are not susceptible to the drawback mentioned above.

### SUMMARY

According to an aspect of this disclosure, a flow path structure includes: a first member including a first flow path configured to allow a fluid to flow therein; a second member including a second flow path configured to allow the fluid to flow therein; and a tubular connection member provided over the first member and the second member and configured to cause the first flow path and the second flow path to communicate with each other, in which the connection member includes a tubular portion extending along an axial direction, a first flange portion integrally provided on one end side of the tubular portion and having an outer diameter larger than an outer diameter of the tubular portion, and a second flange portion integrally provided on the other end side of the tubular portion and having an outer diameter larger than the outer diameter of the tubular portion, and brazed portions are provided that are obtained by brazing between the first flange portion and the first member and between the second flange portion and the second member, respectively.

According to another aspect of this disclosure, a method for manufacturing a flow path structure, the flow path structure including a first member including a first flow path configured to allow a fluid to flow therein, a second member including a second flow path configured to allow the fluid to flow therein, and a tubular connection member provided over the first member and the second member and configured to cause the first flow path and the second flow path to communicate with each other, in which the connection member includes a tubular portion extending along an axial direction, a first flange portion integrally provided on one end side of the tubular portion and having an outer diameter larger than an outer diameter of the tubular portion, and a second flange portion integrally provided on the other end side of the tubular portion and having an outer diameter larger than the outer diameter of the tubular portion, includes: a brazing member disposing step of disposing brazing members between the first flange portion and the first member and between the second flange portion and the second member, respectively; and a brazing step of simultaneously performing heating and brazing between the first flange portion and the first member and between the second flange portion and the second member.

According to still another aspect of this disclosure, a flow path structure includes: a member including a flow path through which a fluid flows; and a tubular connection member provided in the member and communicating with the flow path, in which the connection member includes a tubular portion extending along an axial direction and a protruding portion integrally provided on the tubular portion and having an outer diameter larger than an outer diameter of the tubular portion, and a brazed portion is provided that is obtained by brazing between a surface of the protruding portion facing the member and intersecting the axial direction and a surface of the member facing the protruding portion and intersecting the axial direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram showing an air conditioning system to which a flow path structure is applied;

FIG. 2 is a perspective view of the flow path structure;

FIG. 3 is a side cross-sectional view of the flow path structure;

FIG. 4 is an exploded perspective view of the flow path structure;

FIG. 5 is a diagram showing a connection member according to another embodiment, and

FIG. 6 is a diagram showing a connection member according to another embodiment.

### DETAILED DESCRIPTION

In the related art, for connection of a heat exchanger in a manifold type refrigerant circuit, fitting of a spigot joint portion and fixing by a bolt are generally used. Further, an O ring is provided for sealing in order to prevent a gas from leaking from the spigot joint portion. In such a joint method using the spigot joint portion and the O ring, for example, there is a low possibility that a chlorofluorocarbon refrigerant gas leaks.

However, it is expected that the chlorofluorocarbon refrigerant gas used in the related art is restricted due to an influence of P-FAS restriction mainly in Europe. This restriction is also applied to, for example, an in-vehicle refrigerant circuit. Therefore, it is necessary to replace the chlorofluorocarbon refrigerant gas with a natural refrigerant gas that is not restricted. However, since a natural refrigerant is a low molecular weight gas, in the sealing using the O ring used in the related art, there is a possibility that the natural refrigerant permeates the O ring and then leaks to an atmosphere side. Therefore, a seal member instead of the O ring is required. Therefore, it is conceivable to use a metal gasket or the like, but it is not realistic since a processing cost of a sealing surface increases and the number of bolt fastening portions for withstanding a high-pressure gas increases, which causes an increase in size.

Therefore, a flow path structure disclosed here is configured to be easily implemented at a low cost without increasing the size. Hereinafter, the flow path structure according to the present embodiment will be described. However, the flow path structure is not limited to the following embodiments, and various modifications can be made without departing from the gist of this disclosure.

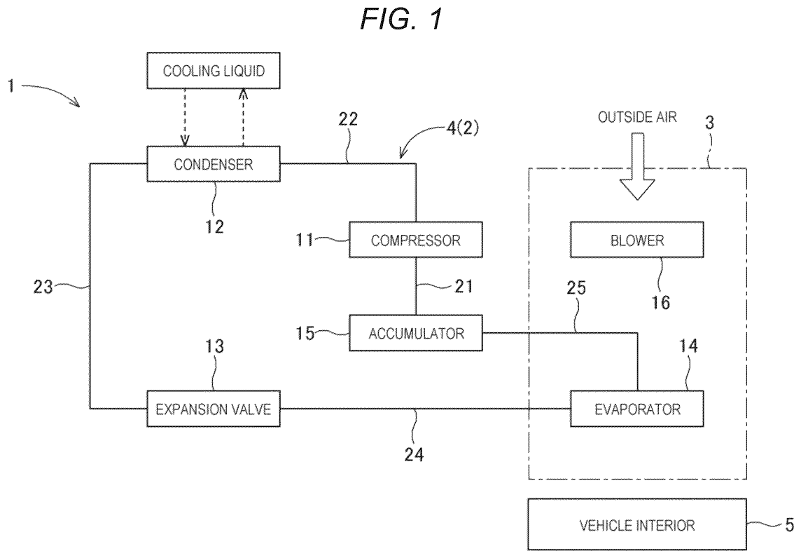

FIG. 1 shows a circuit configuration of an air conditioning system 1 to which the flow path structure is applied. The air conditioning system 1 includes a refrigerant module 2 mounted on a vehicle and an air conditioning unit 3 for cooling a vehicle interior 5. A refrigerant is configured to flow between the refrigerant module 2 and the air conditioning unit 3. The refrigerant flows through a refrigerant flow path 4, and the refrigerant flow path a 4 is included in the refrigerant module 2. A refrigerant such as a hydrofluorocarbon (HFC) or hydrofluoroolefin (HFO) flows through the refrigerant flow path 4.

As shown in FIG. 1, the refrigerant module 2 includes a compressor 11, a condenser 12, an expansion valve 13, and an evaporator 14, and the refrigerant flow path 4 is configured to allow the refrigerant to flow through the compressor 11, the condenser 12, the expansion valve 13, and the evaporator 14. The refrigerant flow path 4 according to the present embodiment is further provided with an accumulator 15.

According to the air conditioning unit 3, it is possible to cool the vehicle interior 5 as described above. When the vehicle interior 5 is to be cooled by the air conditioning unit 3, the accumulator 15 stores a liquid refrigerant, and performs gas-liquid separation of the stored refrigerant. The gaseous refrigerant separated by the accumulator 15 flows through a first refrigerant path 21 and is sent to the compressor 11.

The compressor 11 compresses the refrigerant from the accumulator 15. Accordingly, the refrigerant becomes a high-temperature compressed gas. The compressor 11 sends the refrigerant in the form of the high-temperature compressed gas to the condenser 12 via a second refrigerant path 22. Therefore, the compressor 11 pressure-feeds the refrigerant from the accumulator 15 to the condenser 12.

The condenser 12 causes the refrigerant compressed by the compressor 11 to condense. The condenser 12 is configured such that a cooling liquid that exchanges heat with the refrigerant flows therethrough. In the condenser 12, a flow path that allows the refrigerant to flow and a flow path that allows the cooling liquid to flow are formed separately from each other. The refrigerant is condensed and liquefied by the cooling liquid absorbing heat. The liquefied refrigerant is sent to a third refrigerant path 23. The condenser 12 may be an air-cooled condenser provided near a radiator.

The refrigerant sent from the condenser 12 to the third refrigerant path 23 is sent to the expansion valve 13. In the expansion valve 13, the refrigerant (liquefied refrigerant) flowing through the third refrigerant path 23 at the time of cooling the vehicle interior 5 is expanded to form a low-temperature and low-pressure atomized refrigerant. The atomized refrigerant is sent to a fourth refrigerant path 24.

The evaporator 14 causes the expanded refrigerant in the expansion valve 13 to evaporate and sends the evaporated refrigerant to a fifth refrigerant path 25. As described above, the refrigerant expanded in the expansion valve 13 to form the low-temperature and low-pressure atomized refrigerant flows through the evaporator 14, and such a refrigerant is sent to the evaporator 14. In the evaporator 14, the atomized refrigerant deprives heat from, for example, outside air and evaporates. The evaporated and vaporized refrigerant flows to the accumulator 15 through the fifth refrigerant path 25.

The air conditioning unit 3 includes the evaporator 14 and a blower 16. The blower 16 aspirates the outside air, and sends the aspirated outside air to the evaporator 14.

In the evaporator 14, heat exchange is performed between the outside air sent from the blower 16 and the refrigerant supplied via the fourth refrigerant path 24, and the air after the heat exchange is introduced into the vehicle interior 5. Specifically, the outside air is cooled in the evaporator 14, and cold air is introduced into the vehicle interior 5. Accordingly, cooling can be implemented in the vehicle interior 5.

Although not shown, a cabin condenser disposed in the air conditioning unit 3 and an expansion valve for heating disposed outside the air conditioning unit 3 may be provided in the second refrigerant path 22, and when the vehicle interior 5 is to be heated, the refrigerant from the condenser 12 may be caused to flow to the accumulator 15 so as to bypass the expansion valve 13 and the evaporator 14. Accordingly, the outside air is heated by the cabin condenser, and the vehicle interior 5 can be heated.

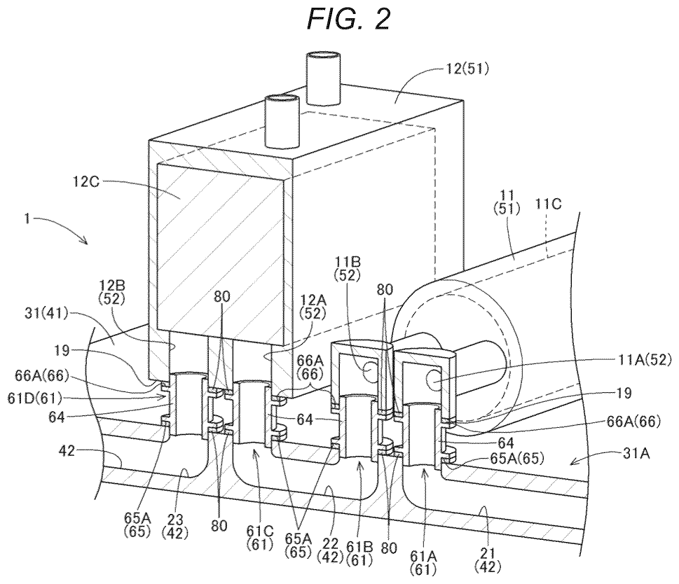

FIG. 2 is a perspective view of the flow path structure according to the present embodiment. FIG. 2 shows a flow path structure applied to the compressor 11 and the condenser 12. The flow path structure includes a first member 41, a second member 51, and a connection member 61. In the present embodiment, the first member 41 corresponds to a manifold 31. The first member 41 is formed of an ADC material (aluminum die-cast material). The second member 51 corresponds to the compressor 11, the condenser 12, and the accumulator 15 (but, the accumulator 15 is not shown in FIG. 2). The second member 51 is formed of a wrought material. Of course, the expansion valve 13 and the evaporator 14 may be used as the second member 51.

The first member 41 includes a first flow path 42 that allows a refrigerant (an example of a “fluid”) to flow therein. In the present embodiment, as described above, the first member 41 corresponds to the manifold 31. Therefore, the first flow path 42 corresponds to the first refrigerant path 21, the second refrigerant path 22, the third refrigerant path 23, the fourth refrigerant path 24, and the fifth refrigerant path 25. Therefore, the first member 41 includes a plurality of first flow paths 42. In FIG. 2, the first refrigerant path 21, the second refrigerant path 22, and the third refrigerant path 23 are shown as the first flow path 42.

The second member 51 includes a second flow path 52 that allows a refrigerant to flow therein. In the present embodiment, as described above, the second member 51 corresponds to the compressor 11, the condenser 12, and the accumulator 15. Therefore, the second flow path 52 in the compressor 11 corresponds to a flow path 11A that is provided in the compressor 11 and that allows the refrigerant to be introduced via the first refrigerant path 21 and a flow path 11B that allows the refrigerant to be discharged via the second refrigerant path 22. Specifically, the second flow path 52 corresponds to the flow path 11A that communicates the first refrigerant path 21 with a compression chamber 11C provided in the compressor 11 and the flow path 11B that communicates the second refrigerant path 22 with the compression chamber 11C provided in the compressor 11.

In addition, the second flow path 52 in the condenser 12 corresponds to a flow path 12A that is provided in the condenser 12 and that allows the refrigerant to be introduced via the second refrigerant path 22 and a flow path 12B that allows the refrigerant to be discharged via the third refrigerant path 23. Specifically, the second flow path 52 corresponds to the flow path 12A that communicates the second refrigerant path 22 with a heat exchange chamber 12C provided in the condenser 12 and the flow path 12B that communicates the third refrigerant path 23 with the heat exchange chamber 12C provided in the condenser 12.

Further, the second flow path 52 in the accumulator 15 corresponds to a flow path (not shown) that is provided in the accumulator 15 and that allows the refrigerant to be introduced via the fifth refrigerant path 25 and a flow path (not shown) that allows the refrigerant to be discharged via the first refrigerant path 21. Specifically, the second flow path 52 corresponds to the flow path that communicates the fifth refrigerant path 25 with a gas-liquid separation chamber (not shown) provided in the accumulator 15 and the flow path that communicates the first refrigerant path 21 with the gas-liquid separation chamber provided in the accumulator 15.

Therefore, the second member 51 corresponds to a member that allows the refrigerant to flow via the manifold 31.

The connection member 61 is provided over the first member 41 and the second member 51, and causes the first flow path 42 and the second flow path 52 to communicate with each other. Further, the connection member 61 is formed in a tubular shape, and an inside thereof is used as a flow path that allows the refrigerant to flow. The connection member 61 is formed of a wrought material.

In the present embodiment, as the connection member 61, a connection member 61A that causes the first refrigerant path 21 of the manifold 31 to communicate with the flow path 11A of the compressor 11, a connection member 61B that causes the second refrigerant path 22 of the manifold 31 to communicate with the flow path 11B of the compressor 11, a connection member 61C that causes the second refrigerant path 22 of the manifold 31 to communicate with the flow path 12A of the condenser 12, a connection member 61D that causes the third refrigerant path 23 of the manifold 31 to communicate with the flow path 12B of the condenser 12, a connection member (not shown) that causes the fifth refrigerant path 25 of the manifold 31 to communicate with the flow path of the accumulator 15, and a connection member (not shown) that causes the first refrigerant path 21 of the manifold 31 to communicate with the flow path of the accumulator 15 are used.

The connection member 61 causes the flow paths in the manifold 31 described above and the flow path in each of the compressor 11, the condenser 12, and the accumulator 15 to communicate with each other via the corresponding flow path formed therein.

Each of the connection members 61 includes a tubular portion 64, a first flange portion 65, and a second flange portion 66. In the present embodiment, the connection member 61 is formed in a cylindrical shape. The tubular portion 64 corresponds to a portion of each of the connection members 61 extending along an axial direction. The tubular portion 64 has a uniform outer diameter along the axial direction, that is, the same outer diameter regardless of a position along the axial direction.

The first flange portion 65 corresponds to a portion integrally provided on one end side of the tubular portion 64 and having an outer diameter larger than the outer diameter of the tubular portion 64. The one end side of the tubular portion 64 is a side on which the first member 41, that is, the manifold 31 in the example in FIG. 2 is located when viewed axially outward from an axial center portion of the tubular portion 64. In the present embodiment, as described above, the outer diameter of the tubular portion 64 is uniform along the axial direction, and the first flange portion 65 has an outer diameter larger than the outer diameter of the tubular portion 64. The first flange portion 65 is formed coaxially with the tubular portion 64. Being provided integrally means that the tubular portion 64 and the first flange portion 65 are formed as a single member. Therefore, the first flange portion 65 is formed as a single member in a state of protruding radially outward in an annular shape with respect to an outer peripheral surface of the tubular portion 64.

The second flange portion 66 corresponds to a portion integrally provided on the other end side of the tubular portion 64 and having an outer diameter larger than the outer diameter of the tubular portion 64. The other end side of the tubular portion 64 is a side on which the second member 51, that is, the compressor 11 and the condenser 12 in the example in FIG. 2 are located when viewed axially outward from the axial center portion of the tubular portion 64. In the present embodiment, similar to the first flange portion 65, the second flange portion 66 has an outer diameter larger than the outer diameter of the tubular portion 64, and is formed coaxially with the tubular portion 64. The second flange portion 66 is formed as a single member with the tubular portion 64. Therefore, the second flange portion 66 is formed as a single member in a state of protruding radially outward in an annular shape with respect to the outer peripheral surface of the tubular portion 64.

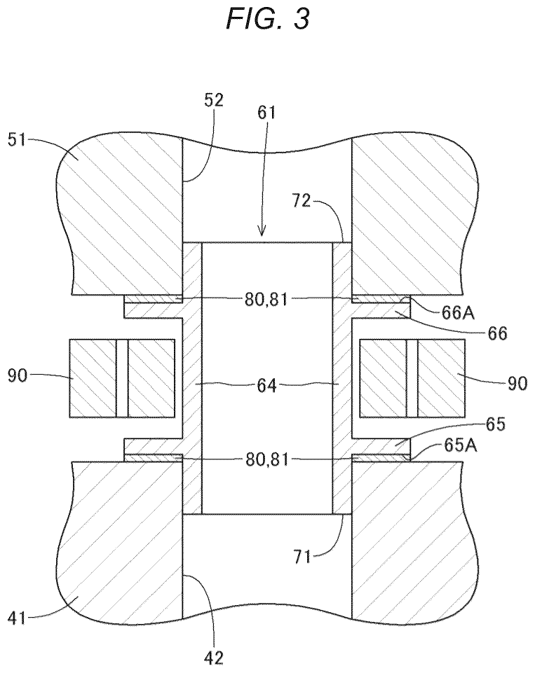

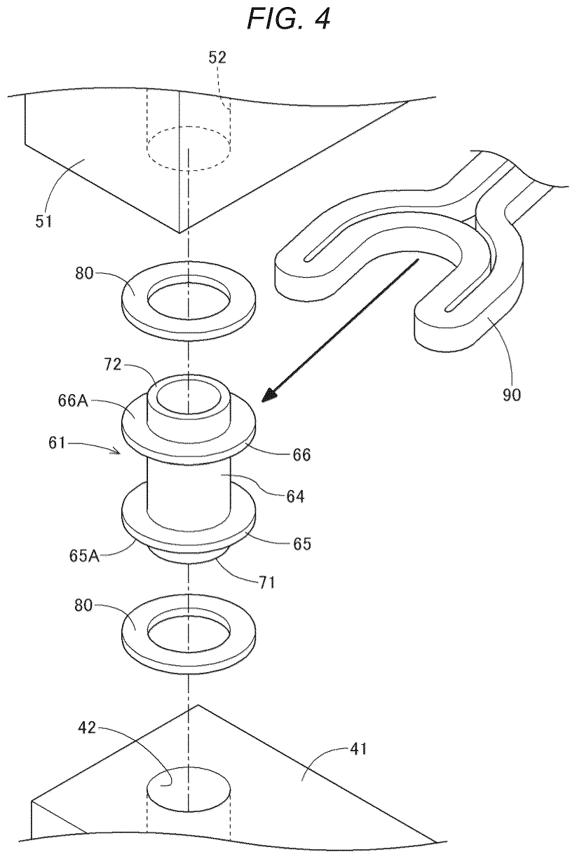

FIG. 3 shows a side cross-sectional view of the flow path structure. FIG. 4 is an exploded perspective view of FIG. 3. The connection member 61 includes the annular first flange portion 65 protruding radially outward from the outer peripheral surface of the tubular portion 64 at a position closer to an axial center than an end portion 71 on one axial side of the tubular portion 64, and includes the annular second flange portion 66 protruding radially outward from the outer peripheral surface of the tubular portion 64 at a position closer to the axial center than an end portion 72 on the other axial side of the tubular portion 64.

In the connection member 61, an end portion 71 side of the tubular portion 64 is inserted into the first member 41. In the example in FIG. 2, the connection member 61 is inserted into the first flow path 42 of the first member 41, that is, the flow paths (the first refrigerant path 21, the second refrigerant path 22, and the third refrigerant path 23) of the manifold 31. At this time, assemble can be performed with a brazing member 80 sandwiched between an end surface 65A of the first flange portion 65 on the one axial side and a surface of the first member 41 on a first flange portion 65 side, that is, an outer surface 31A of the manifold 31.

Further, in the connection member 61, an end portion 72 side of the tubular portion 64 is inserted into the second member 51. In the example in FIG. 2, the connection member 61 is inserted into the second flow path 52 of the second member 51, that is, the flow paths (flow paths 11A, 11B, 12A, and 12B) of the compressor 11 and the condenser 12. At this time, the assemble can be performed with a brazing member 80 sandwiched between an end surface 66A of the second flange portion 66 on the other axial side and a surface of the second member 51 on a second flange portion 66 side, that is, an outer surface 19 of the compressor 11 and the condenser 12.

As described above, a step of disposing the brazing member 80 between the first flange portion 65 and the first member 41, and between the second flange portion 66 and the second member 51, that is, between the end surface 65A of the first flange portion 65 on the one axial side and the outer surface 31A of the manifold 31, and between the end surface 66A of the second flange portion 66 on the other axial side and the outer surface 19 of the compressor 11 and the condenser 12 is referred to as a brazing member disposing step in a method for manufacturing a flow path structure.

A horseshoe-shaped induction heating coil 90 (high-frequency coil) is disposed between the first flange portion 65 and the second flange portion 66 of the connection member 61 assembled in this manner so as to sandwich the tubular portion 64 of the connection member 61 from radially outward, and is energized. Accordingly, the connection member 61 is actively heated, and the brazing member 80 between the first flange portion 65 and the first member 41 and the brazing member 80 between the second flange portion 66 and the second member 51, that is, the brazing member 80 between the first flange portion 65 and the manifold 31 and the brazing member 80 between the second flange portion 66 and the compressor 11 and the condenser 12 can be melted at the same time, and meanwhile, a brazed portion 81 is formed (a fillet may be formed).

In the present embodiment, as shown in FIG. 3, the brazing member 80 between the first flange portion 65 and the first member 41 and the brazing member 80 between the second flange portion 66 and the second member 51 are provided to at least partially overlap each other when viewed along the axial direction. In the example in FIG. 3, the brazing member 80 between the first flange portion 65 and the first member 41 and the brazing member 80 between the second flange portion 66 and the second member 51 are provided to entirely overlap each other when viewed along the axial direction. Accordingly, a distance (interval) from the induction heating coil 90 to the brazing member 80 between the first flange portion 65 and the first member 41 and a distance (interval) from the induction heating coil 90 to the brazing member 80 between the second flange portion 66 and the second member 51 can be shortened, and the brazing member 80 between the first flange portion 65 and the first member 41 and the brazing member 80 between the second flange portion 66 and the second member 51 can be simultaneously and efficiently heated.

As described above, a step of simultaneously performing heating and brazing between the first flange portion 65 and the first member 41 and between the second flange portion 66 and the second member 51, that is, a step of simultaneously performing heating and brazing between the end surface 65A of the first flange portion 65 on the one axial side and the outer surface 31A of the manifold 31 and between the end surface 66A of the second flange portion 66 on the other axial side and the outer surface 19 of the compressor 11 and the condenser 12 is referred to as a brazing step in the method for manufacturing a flow path structure.

The heating between the first flange portion 65 and the first member 41 and the heating between the second flange portion 66 and the second member 51 in the brazing step, that is, the heating between the end surface 65A of the first flange portion 65 on the one axial side and the outer surface 31A of the manifold 31 and the heating between the end surface 66A of the second flange portion 66 on the other axial side and the outer surface 19 of the compressor 11 and the condenser 12 are performed by the high-frequency induction heating as described above.

By performing the brazing as described above, the brazed portion 81 between the first flange portion 65 and the first member 41 and the brazed portion 81 between the second flange portion 66 and the second member 51 can be formed to at least partially overlap each other when viewed along the axial direction. That is, the brazed portion 81 between the first flange portion 65 and the manifold 31 and the brazed portion 81 between the second flange portion 66 and the compressor 11 and the condenser 12 can be formed to at least partially overlap each other when viewed along the axial direction. Therefore, the connection member 61 can be provided over the manifold 31, the compressor 11, and the condenser 12 with a uniform force, and it is possible to prevent leakage of the refrigerant from between the first flange portion 65 and the manifold 31 and between the second flange portion 66 and the compressor 11 and the condenser 12.

By manufacturing the flow path structure using the above manufacturing method, it is possible to perform the brazing even when a base material of the manifold 31 is an aluminum die-cast material such as “ADC12”, which is difficult to be brazed. In addition, when the aluminum die-cast material is directly heated at a high frequency, once the aluminum die-cast material reaches a vicinity of a melting point of the base material, there is a high possibility that a gas contained inside the base material comes to the surface, or the base material is softened to lose a shape, but it is possible to minimize an influence on the base material of the manifold 31 by using an “A6000-based” wrought material or the like as a joint component and preferentially heating the connection member 61. Therefore, by using the high-frequency induction heating as described above, it is possible to perform local brazing instead of in-furnace brazing. The heating of the brazing member 80 is not limited to the high-frequency heating as long as the heating is a method capable of locally and uniformly heating the brazing member 80, and another method using flame, halogen, or laser may be used.

### Other Embodiments

Next, other embodiments of the flow path structure and the method for manufacturing a flow path structure will be described.

In the above embodiment, the example in which the flow path structure is applied to the circuit configuration of the air conditioning system 1 is described. However, the flow path structure can also be used in a circuit configuration different from the air conditioning system 1 (for example, a cooling liquid circuit or a gaseous fuel circuit).

In the above embodiment, the brazed portion 81 between the first flange portion 65 and the first member 41 and the brazed portion 81 between the second flange portion 66 and the second member 51 are described to entirely overlap each other when viewed along the axial direction. However, the brazed portion 81 between the first flange portion 65 and the first member 41 and the brazed portion 81 between the second flange portion 66 and the second member 51 may partially overlap each other when viewed along the axial direction. Alternatively, the brazed portion 81 between the first flange portion 65 and the first member 41 and the brazed portion 81 between the second flange portion 66 and the second member 51 may not overlap each other when viewed along the axial direction.

In the above embodiment, the first member 41 is described to be the manifold 31 including the plurality of first flow paths 42, and the second member 51 is described to be a member that allows the fluid to flow via the manifold 31. However, when the flow path structure is applied to the circuit configuration of the air conditioning system 1, the first member 41 may be a member different from the manifold 31, and the second member 51 may be a member different from the member that allows the fluid to flow via the manifold 31.

In the above embodiment, in the method for manufacturing a flow path structure, the heating between the first flange portion 65 and the first member 41 and the heating between the second flange portion 66 and the second member 51 in the brazing step are described to be performed by the induction heating. However, the heating between the first flange portion 65 and the first member 41 and the heating between the second flange portion 66 and the second member 51 in the brazing step may be performed by a heating method different from the induction heating. As such a heating method, for example, heating using a heat gun may be performed.

In the above embodiment, the first member 41 is described to be formed of the ADC material, the second member 51 is described to be formed of the wrought material, and the connection member 61 is described to be formed of the wrought material. However, the first member 41 may be formed of a wrought material, the second member 51 may be formed of an ADC material, and the connection member 61 may be formed of an ADC material.

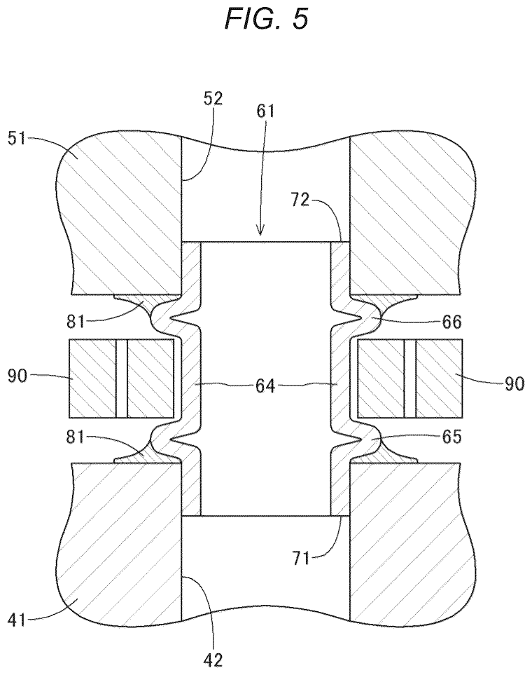

In the above embodiment, the first flange portion 65 and the second flange portion 66 of the connection member 61 are shown in FIG. 3 in a state where plate-shaped members protrude radially outward with respect to the outer peripheral surface of the tubular portion 64. However, as shown in FIG. 5, the connection member 61 may be formed such that a part of the tubular portion 64 protrudes in a state of being curved radially outward. In this case, as shown in FIG. 5, the brazed portions 81 are formed in a fillet shape between the first member 41 and the first flange portion 65 and between the second member 51 and the second flange portion 66, respectively.

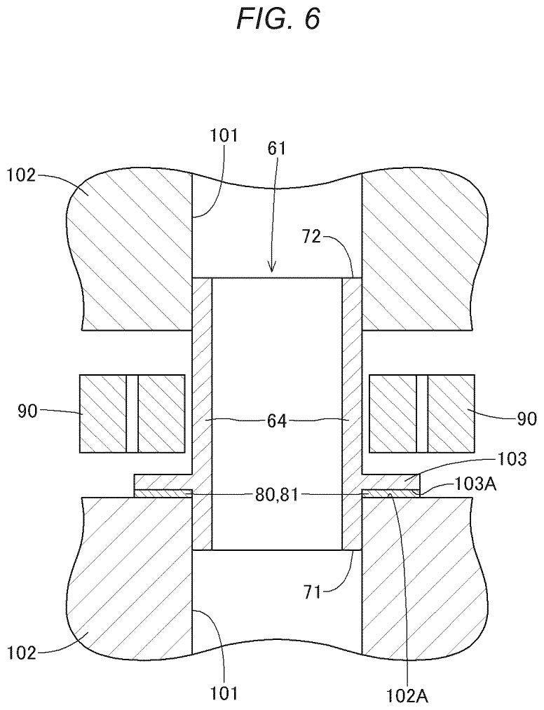

In the above embodiment, it is described that brazing is performed between the first flange portion 65 on one end side of the tubular portion 64 of the connection member 61 and the first member 41 and between the second flange portion 66 on the other end side of the tubular portion 64 of the connection member 61 and the second member 51. That is, it is described that brazing is performed on both sides of the tubular portion 64 of the connection member 61 in the axial direction. However, as shown in FIG. 6, a configuration can be applied in which brazing is performed on one side of the tubular portion 64 of the connection member 61 in the axial direction.

In this case, the flow path structure may have a configuration as follows.

A member 102 including a flow path 101 through which a fluid flows inside, and the tubular connection member 61 provided in the member 102 and communicating with the flow path 101 may be provided, the connection member 61 may include the tubular portion 64 extending along the axial direction and a protruding portion 103 integrally provided on the tubular portion 64 and having an outer diameter larger than the outer diameter of the tubular portion 64, and the brazed portion 81 may be provided that is obtained by brazing between a surface 103A of the protruding portion 103 facing the member 102 and intersecting the axial direction and a surface 102A of the member 102 facing the protruding portion 103 and intersecting the axial direction.

In the example in FIG. 6, the connection member 61 is provided with the protruding portion 103 on the end portion 71 side, and the brazed portion 81 is provided that is obtained by brazing between the surface 103A of the protruding portion 103 on the end portion 71 side and the surface 102A of the member 102 on the end portion 71 side. The end portion 72 side of the connection member 61 may be implemented such that, for example, the end portion 72 side of the tubular portion 64 is press-fitted into the flow path 101 of the member 102 on the end portion 72 side, or may be implemented such that a female screw portion is formed on an inner peripheral surface of the flow path 101 of the member 102 on the end portion 72 side, a male screw portion is formed on the outer peripheral surface of the tubular portion 64 on the end portion 72 side, and the female screw portion and the male screw portion are screwed to each other. Of course, the end portion 72 side of the tubular portion 64 may be fixed to the flow path 101 of the member 102 by a method other than these.

For example, when the axial center of the tubular portion 64 of the connection member 61 is disposed along the vertical direction, and the protruding portion 103 is provided on a lower side of the tubular portion 64 of the connection member 61, a weight of the connection member 61 acts on the brazed portion 81, so that the connection member 61 can be more firmly connected, and leakage of the fluid can be prevented.

Although not shown, the connection member 61 may be provided with the protruding portion 103 on the end portion 72 side, and the brazed portion 81 may be provided that is obtained by brazing between the surface 103A of the protruding portion 103 on the end portion 72 side and the surface 102A of the member 102 on the end portion 72 side. In this case, the end portion 71 side of the connection member 61 may be implemented such that, for example, the end portion 71 side of the tubular portion 64 is press-fitted into the flow path 101 of the member 102 on the end portion 71 side, or may be implemented such that the female screw portion is formed on the inner peripheral surface of the flow path 101 of the member 102 on the end portion 71 side, the male screw portion is formed on the outer peripheral surface of the tubular portion 64 on the end portion 71 side, and the female screw portion and the tubular portion 64 are screwed to each other. Of course, the end portion 71 side of the tubular portion 64 may be fixed to the flow path 101 of the member 102 by a method other than these methods.

For example, when the axial center of the tubular portion 64 of the connection member 61 is disposed along the vertical direction, and the protruding portion 103 is provided on an upper side of the tubular portion 64 of the connection member 61, a weight of the member 102 (the member 102 on the end portion 72 side) on an upper side in the vertical direction acts on the brazed portion 81, so that the connection member 61 can be more firmly connected, and the leakage of the fluid can be prevented.

Of course, the protruding portion 103 may be provided on each of the end portion 71 side and the end portion 72 side of the connection member 61, and the brazed portions 81 may be provided that are obtained by brazing between the surface 103A of the protruding portion 103 on the end portion 71 side and the surface 102A of the member 102 on the end portion 71 side and between the surface 103A of the protruding portion 103 on the end portion 72 side and the surface 102A of the member 102 on the end portion 72 side.

### Overview of Above Embodiments

Hereinafter, an outline of the flow path structure and the method for manufacturing a flow path structure described above will be described.
(1) A flow path structure includes a first member 41 including a first flow path 42 that allows a refrigerant (fluid) to flow therein, a second member 51 including a second flow path 52 that allows the refrigerant to flow therein, and a tubular connection member 61 provided over the first member 41 and the second member 51 and causing the first flow path 42 and the second flow path 52 to communicate with each other, in which the connection member 61 includes a tubular portion 64 extending along an axial direction, a first flange portion 65 integrally provided on one end side of the tubular portion 64 and having an outer diameter larger than an outer diameter of the tubular portion 64, and a second flange portion 66 integrally provided on the other end side of the tubular portion 64 and having an outer diameter larger than the outer diameter of the tubular portion 64, and brazed portions 81 are provided that are obtained by brazing between the first flange portion 65 and the first member 41 and between the second flange portion 66 and the second member 51, respectively.

According to this configuration, by performing the brazing between the first flange portion 65 and the first member 41 and between the second flange portion 66 and the second member 51, the first flow path 42 of the first member 41 and the second flow path 52 of the second member 51 can be caused to communicate with each other via the connection member 61. Therefore, it is possible to easily manufacture the flow path structure in which the first member 41 and the second member 51 are caused to communicate with each other in a short time.
(2) In the flow path structure according to (1), the brazed portion 81 between the first flange portion 65 and the first member 41 and the brazed portion 81 between the second flange portion 66 and the second member 51 may at least partially overlap each other when viewed along the axial direction.

According to this configuration, since the brazed portion between the first flange portion 65 and the first member 41 and the brazed portion between the second flange portion 66 and the second member 51 can be brought close to each other, the brazed portion 81 between the first flange portion 65 and the first member 41 and the brazed portion 81 between the second flange portion 66 and the second member 51 can be simultaneously formed. Therefore, it is possible to simultaneously perform the brazing at two places in one step.
(3) In the flow path structure according to (1) or (2), the first member 41 may be a manifold 31 including a plurality of the first flow paths 42, and the second member 51 may be a member that allows the fluid to flow via the manifold 31.

According to the present configuration, the fluid can be caused to flow between the manifold 31 constituting the first member 41 and the member constituting the second member 51 via the connection member 61. Therefore, a pipe connecting the first member 41 and the second member 51 can be simplified.
(4) A method for manufacturing a flow path structure, the flow path structure including a first member 41 including a first flow path 42 that allows a fluid to flow therein, a second member 51 including a second flow path 52 that allows the fluid to flow therein, and a tubular connection member 61 provided over the first member 41 and the second member 51 and causing the first flow path 42 and the second flow path 52 to communicate with each other, in which the connection member 61 includes a tubular portion 64 extending along an axial direction, a first flange portion 65 integrally provided on one end side of the tubular portion 64 and having an outer diameter larger than an outer diameter of the tubular portion 64, and a second flange portion 66 integrally provided on the other end side of the tubular portion 64 and having an outer diameter larger than the outer diameter of the tubular portion 64, includes: a brazing member disposing step of disposing brazing members 80 between the first flange portion 65 and the first member 41 and between the second flange portion 66 and the second member 51, respectively; and a brazing step of simultaneously performing heating and brazing between the first flange portion 65 and the first member 41 and between the second flange portion 66 and the second member 51.

According to this configuration, by performing the brazing between the first flange portion 65 and the first member 41 and between the second flange portion 66 and the second member 51, it is possible to perform the brazing for causing the first flow path 42 of the first member 41 and the second flow path 52 of the second member 51 to communicate with each other via the connection member 61. Therefore, it is possible to easily manufacture the flow path structure in which the first flow path 42 of the first member 41 and the second flow path 52 of the second member 51 communicate with each other in a short time.
(5) In the method for manufacturing a flow path structure according to (4), the heating between the first flange portion 65 and the first member 41 and the heating between the second flange portion 66 and the second member 51 in the brazing step may be performed by induction heating.

According to this configuration, it is possible to perform local heating between the first flange portion 65 and the first member 41 and between the second flange portion 66 and the second member 51. Therefore, efficiency of the step of communicating the first flow path 42 of the first member 41 with the second flow path 52 of the second member 51 can be improved.
(6) A flow path structure includes a member 102 including a flow path 101 through which a fluid flows; and a tubular connection member 61 provided in the member 102 and communicating with the flow path 101, in which the connection member 61 includes a tubular portion 64 extending along an axial direction and a protruding portion 103 integrally provided on the tubular portion 64 and having an outer diameter larger than an outer diameter of the tubular portion 64, and a brazed portion 81 is provided that is obtained by brazing between a surface 103A of the protruding portion 103 facing the member 102 and intersecting the axial direction and a surface 102A of the member 102 facing the protruding portion 103 and intersecting the axial direction.

For example, when brazing is performed on the portion of the tubular portion 64, if there is a tolerance between an inner diameter of the member 102 and the outer diameter of the tubular portion 64, an amount of the brazing member 80 used for brazing may vary. However, according to this configuration, since brazing is performed on both surfaces of the protruding portion 103 and the member 102, it is possible to always set an appropriate amount of the brazing member 80. In addition, for example, when the axial center of the tubular portion 64 of the connection member 61 is along the vertical direction, and the protruding portion 103 is provided on the lower side of the tubular portion 64 of the connection member 61, the weight of the connection member 61 acts on the brazed portion 81, so that the connection member 61 can be more firmly connected, and the leakage of the fluid can be prevented. In addition, for example, when the axial center of the tubular portion 64 of the connection member 61 is along the vertical direction, and the protruding portion 103 is provided on the upper side of the tubular portion 64 of the connection member 61, a weight of the upper member 102 acts on the brazed portion 81, so that the connection member 61 can be more firmly connected, and the leakage of the fluid can be prevented.
(7) In the flow path structure according to (6), the connection member 61 may be provided across the two members 102, and may include the protruding portion 103 on one end side and the other end side of the tubular portion 64, and the brazed portion 81 may be provided on one end side and the other end side in the axial direction.

According to this configuration, by performing brazing between the protruding portion 103 and the member 102 on one axial end side and between the protruding portion 103 and the member 102 on the other axial end side, the flow path 101 in the member 102 on the one axial end side and the flow path 101 in the member 102 on the other axial end side can communicate with each other via the connection member 61. Therefore, it is possible to easily manufacture the flow path structure in which the member 102 on the one axial end side and the member 102 on the other axial direction communicate with each other in a short time. In addition, for example, when the axial center of the tubular portion 64 of the connection member 61 is provided along the vertical direction, in the protruding portion 103 on the lower side of the tubular portion 64 of the connection member 61, the weights of the connection member 61 and the member 102 act on the brazed portion 81, so that the connection member 61 can be more firmly connected, and the leakage of the fluid can be prevented. In the protruding portion 103 on the upper side of the tubular portion 64 of the connection member 61, the weight of the member 102 thereabove acts on the brazed portion 81, so that the connection member 61 can be more firmly connected, and the leakage of the fluid can be prevented.

### Industrial Applicability

The technique according to this disclosure can be used for a flow path structure that allows a fluid to flow and a method for manufacturing such a flow path structure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A flow path structure comprising:
a first member including a first flow path configured to allow a fluid to flow therein;
a second member including a second flow path configured to allow the fluid to flow therein; and
a tubular connection member provided over the first member and the second member and configured to cause the first flow path and the second flow path to communicate with each other, wherein
the connection member includes a tubular portion extending along an axial direction, a first flange portion integrally provided on one end side of the tubular portion and having an outer diameter larger than an outer diameter of the tubular portion, and a second flange portion integrally provided on the other end side of the tubular portion and having an outer diameter larger than the outer diameter of the tubular portion, and
brazed portions are provided that are obtained by brazing between the first flange portion and the first member and between the second flange portion and the second member, respectively.

2. The flow path structure according to claim 1, wherein
the brazed portion between the first flange portion and the first member and the brazed portion between the second flange portion and the second member at least partially overlap each other when viewed along the axial direction.

3. The flow path structure according to claim 1, wherein
the first member is a manifold including a plurality of the first flow paths, and
the second member is a member configured to allow the fluid to flow via the manifold.

4. The flow path structure according to claim 2, wherein
the first member is a manifold including a plurality of the first flow paths, and
the second member is a member configured to allow the fluid to flow via the manifold.

5. A method for manufacturing a flow path structure, the flow path structure including
a first member including a first flow path configured to allow a fluid to flow therein,
a second member including a second flow path configured to allow the fluid to flow therein, and
a tubular connection member provided over the first member and the second member and configured to cause the first flow path and the second flow path to communicate with each other, in which
the connection member includes a tubular portion extending along an axial direction, a first flange portion integrally provided on one end side of the tubular portion and having an outer diameter larger than an outer diameter of the tubular portion, and a second flange portion integrally provided on the other end side of the tubular portion and having an outer diameter larger than the outer diameter of the tubular portion, the method comprising:
a brazing member disposing step of disposing brazing members between the first flange portion and the first member and between the second flange portion and the second member, respectively; and
a brazing step of simultaneously performing heating and brazing between the first flange portion and the first member and between the second flange portion and the second member.

6. The method for manufacturing a flow path structure according to claim 5, wherein
the heating between the first flange portion and the first member and the heating between the second flange portion and the second member in the brazing step are performed by induction heating.

7. A flow path structure comprising:
a member including a flow path through which a fluid flows; and
a tubular connection member provided in the member and communicating with the flow path, wherein
the connection member includes a tubular portion extending along an axial direction and a protruding portion integrally provided on the tubular portion and having an outer diameter larger than an outer diameter of the tubular portion, and
a brazed portion is provided that is obtained by brazing between a surface of the protruding portion facing the member and intersecting the axial direction and a surface of the member facing the protruding portion and intersecting the axial direction.

8. The flow path structure according to claim 7, wherein
the connection member is provided across the two members, and includes the protruding portion on one end side and the other end side of the tubular portion, and
the brazed portion is provided on one end side and the other end side in the axial direction.
